(19) United States
(12) Patent Application Publication
(10) Pub. No.: US 2007/0031734 A1
(43) Pub. Date: Feb. 8, 2007

(54) Electrolyte additives for lithium metal and lithium ion rechargeable batteries

(76) Inventor: Jiang Fan, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/445,392

(22) Filed: May 31, 2006

Related U.S. Application Data
(60) Provisional application No. 60/705,099, filed on Aug. 2, 2005.

(51) Int. Cl. H01M 2/16; H01M 10/04

(52) U.S. Cl. 429/246; 429/137; 429/326; 429/330; 429/331; 29/623.1; 29/623.5

(57) ABSTRACT

An electrolyte providing an improved SEI layer for a lithium ion cell or lithium metal cell battery. The addition of one or a plurality of additives to the electrolyte of a lithium ion cell or lithium metal cell battery yields an improved SEI layer in the battery. The SEI layer enhanced by the additives to the electrolyte has been found to improve cell capacity, the cycle life, and the high temperature stability of the battery in which it is employed.

### FIELD OF THE INVENTION

This application claims priority from U.S. provisional application Ser. No. 60/705,099, filed Aug. 2, 2005.

The disclosed device relates to the field of batteries. More particularly it relates to a non-aqueous electrolyte for use in a Lithium ion cell or lithium metal cell (primary and secondary batteries) employing one or a combination of additives used singularly or in combination to enhance the Solid Electrolyte Interface (SEI) film layer formed on the negative electrode during the initial charge and discharge cycle. The electrolyte formed using the disclosed additives and operatively placed in a battery thereby improves the cell capacity, the cycle life, and the high temperature stability of the battery in which it is employed.

### BACKGROUND OF THE INVENTION

Conventional electrochemical devices such as batteries are used widely in the world as a source of portable electrical power for devices requiring direct electrical current. Such battery devices provide the electrical power for everything from watches to automobiles, and as a consequence, great value is placed on the reliability, energy density or electrical storage capacity of these devices and their continued ability to provide an adequate supply of electrical current to the communicating electrical device. Currently, lithium ion cells and lithium metal cells are a preferred battery configuration due to the inherent ability of such cells to store and discharge a large volume of electrical energy in relation to their individual volume and weight.

During the initial charging process of lithium batteries, highly reactive lithium reacts with the solvent like EC in the electrolyte to form a thin film on a surface of the negative electrode. The thin film so formed is generally called a solid electrolyte interface (SEI) film or layer. This SEI layer not only prevents further reactions between lithium ions and the electrolyte during charging and discharging, but also acts as an ion tunnel, allowing the passage of only lithium ions.

The SEI layer is very important to the cell safety, cycle life, and the prismatic cell bulging, and yet the formation of the SEI layer can be controlled by adding some chemical compounds which can react with lithium at a higher voltage than the key solvent ethylene carbonate or EC in the electrolyte. Therefore, various kinds of chemical compounds have been tried for the possible additives for the application. For instance, P₂O₅ has been patented as an additive for rechargeable lithium ion batteries (Canadian patent No. 2150877 filed in Jun. 2, 1995); the inorganic gases like CO₂ and SO₂ have also been reported as good additives for lithium ion batteries; and, the organic solvent like vinyl carbonate (VC) is well known for enhancing the cycle life of the lithium ion cell with the natural graphite negative.

However, there are some weak points in these additives. The dissolution of P₂O₅ is limited in the electrolyte while the carbon dioxide and sulfur dioxide are a gas at the room temperature, rendering it very difficulty to use. The SEI layer formed by VC may not be very stable at the high temperature because the SEI layer formed by VC may contain substantial quantities of organic salt which may dissolve significantly at the high temperature, which may lead to a poor cycle life and a prismatic cell bulge at the high temperature. As a result, the search continues for a new additive in the field of lithium ion cells. This is because enhancing the SEI layer to better protect the negative electrode and resist the aforementioned problems would greatly enhance the life span and performance of such batteries.

During the initial charge of a lithium ion battery, lithium ions are released from the lithium-transition metal oxide positive electrode of the battery. The lithium ions are then communicated to the carbonaceous negative electrode whereupon the ions are intercalated into the carbon. The high reactivity of lithium causes a reaction with the electrolyte to cause the formation of a thin film or layer on the surface of the negative electrode. This film is referred to as an organic solid electrolyte interface (SEI) film.

This SEI film formed during the initial charge of the battery forms a barrier to prevent the reaction between lithium and the electrolyte during charging and discharging. The layer also acts as an ion tunnel, allowing the passage of only lithium ions, thereby preventing solvent cointercalation and disintegration of the structure of the carbonaceous negative electrode.

It is generally accepted that once SEI layer is formed on the underlying electrode, lithium does not again react with the electrode such that the electrolyte solution no longer decomposes, and stable charging and discharging of the battery is provided.

Typically the performance and cycle life of lithium ion batteries employing a conventional electrolyte is less than satisfactory without the inclusion of a good additive to the electrolyte which enhances this initial SEI layer formation. The new additives herein disclosed, when included in the electrolyte singularly or in combination, have been found through experimentation to form a superior SEI layer which enhances the protection of the negative electrode. This results in an improved battery with a longer life cycle and constant performance over that cycle.

The cell capacity of a conventional lithium ion battery depends on its electrolyte because the formation of the SEI layer by the reaction between the electrolyte and negative electrode material will cause some irreversible loss. This irreversible capacity loss has been minimized and cell capacity thus enhanced through employment of one or a plurality of the additives disclosed herein which have been found to be particularly effective in enhancing the SEI layer. Further, the additives herein described and disclosed, either singularly or in combination, can enhance the formation of the SEI layer with a very small amount of the additives by volume to the electrolyte.

Because prismatic cells will swell at the high temperature partially because of the gas products generated by the reaction between the negative electrode materials and electrolyte due to the conventional SEI layer dissolution at the high temperature, it is particularly attractive to enhance the SEI layer to decrease this problem.

Experimentation has shown that the new additives discussed and described herein also enhance SEI layer resistance to high temperature degradation of the negative electrode. It has been found that forming an SEI layer on the negative surface, consisting of sulfur and phosphorus-based compounds which are difficult to dissolve into the electrolyte at the high temperature, enhances the layer to resist high temperature degradation. Therefore, the SEI layer on the negative electrode with the one or a plurality of the disclosed additives is protected and the cell swelling is reduced.

There is as such a pressing need for an electrolyte and battery employing it that yields enhanced SEI layer on the battery electrode that resists the noted current problems inherent to that layer in such batteries. The additives employed should be easily incorporated into current manufacturing processes and should yield an improved SEI layer upon carbonaceous electrodes to enhance battery performance and life span.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other methods and systems for carrying out the several purposes of the present invention. It is important, therefore, that the claims be regarded as including such equivalent construction insofar as they do not depart from the spirit and scope of the present invention.

An object of this invention is the provision of electrolyte additives in the electrolyte for a battery which will set a stable SEI layer to protect the negative from the reaction with the solvent and salt in the electrolyte.

Another object of this invention is the provision of an improved electrolyte for use in a battery which provides a higher cell capacity to the resulting Lithium ion cell or lithium metal secondary batteries.

An additional object of this invention, is the provision of an electrolyte having additives which enhance the SEI layer in a battery which yields a battery cell having improved stability in high temperatures.

Yet a further object of this invention is the provision of an electrolyte which when employed in combination with a battery cell, yields improved cycle life of the cell.

A further object of this invention is the provision of a battery cell and method of manufacture thereof that yields an improved SEI layer on the negative electrode employing the electrolyte and additives herein disclosed and described.

These together with other objects and advantages which will become subsequently apparent reside in the details of the construction and operation as more fully hereinafter described and claimed, reference being had to the accompanying drawings forming a part thereof, wherein like numerals refer to like parts throughout.

### SUMMARY OF THE INVENTION

The above problems and others are overcome by the herein disclosed additives to the electrolyte employed in a lithium battery. Three additives have been found through experimentation used singularly or in combination to enhance the SEI layer in the battery which forms during the initial charge. The additives may be employed in any lithium ion cell or lithium metal cell battery. The additives which may be employed singularly or in combination are from a group of additives which includes:

A) The structure of the first additive is R₁O₂S—[—P(═O) (OSO₂R₂)—O—]ₙ-SO₂R₃ where R1, R2 and R3 are independently or simultaneously an alkyl group, a phenyl group, or a halogen-substitute alkyl or/and phenyl groups. The studied compound is phosphorus pentoxide methanesulfonic acid with the structure R₁OS—[—P(═O) (OSO₂R₂)—O—]ₙ-SO₂R₃ where R1, R2 and R3 are all CH3 group. Since these are all liquids in commercial form, they are easily included into conventional manufacturing processes.

B) The second additive is phosphonic Acid Tris (2-n-butoxyethyl) Ester with the following structure: CH₃((CH₂)₃OCH₂CH₂O)₃P═O.

C) The structure of the third additive is R₁R₂C(OSO₂R₃)—R₄C(OSO₂R₅)—R₆R₇C—R₈C(OSO₂R₉) where R1-R9 are independently or simultaneously an alkyl group, a phenyl group, or a halogen-substitute alkyl or/and phenyl group. A third additive example is 1,2,4-Tris (methane sulfonyloxy) butane with the following structure: C₇H₁₆O₉S₃.

Whether employed singularly or in combination of one or all of the additives in the formed electrolyte, experimentation has shown that the benefits of the electrolyte are significantly enhanced when added to a concentration of 0.01%-20% by volume of the electrolyte. A particularly preferred concentration of each of the additives chosen to be employed for a concentration of 0.1%-5% by volume of each additive in the formed electrolyte has been shown to work well.

The addition of one or a combination of the above-referenced additives has been found to significantly enhance the formed SEI layer thereby providing improved cycle life, higher capacity of the battery itself and therefore better efficiency, and improved high temperature stability when added to the electrolyte used in lithium ion cell and lithium metal cell (primary and secondary batteries).

With respect to the above description then, it is to be realized that the optimum relationships for invention are to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction, mixtures, and operation shown and described, and accordingly, all suitable modifications and equivalents may be resorted to, falling within the scope of the invention.

### BRIEF DESCRIPTION OF THE DRAWING FIGURES

The accompanying drawings which are incorporated in and form a part of this specification illustrate the improved results obtained with the addition of the additives identified.

FIG. 1 is a graphic depiction of the reduction peak of phosphorus pentoxide methanesulfonic acid additive and resulting cell performance improvement over conventional electrolyte.

FIG. 2 is a graphic depiction of the reduction peak of a 1% ethylene trithicarbonate additive to an electrolyte solution and resulting cell performance improvement over conventional electrolyte.

FIG. 3 depicts a cross sectional view of a non-aqueous electrolyte cell yielding the improved SEI layer when employing the improved electrolyte according to the invention.

FIG. 4 is a cross-sectional view of a non-aqueous electrolyte secondary cell or prismatic cell yielding the improved SEI layer when employing the improved electrolyte according to the invention.

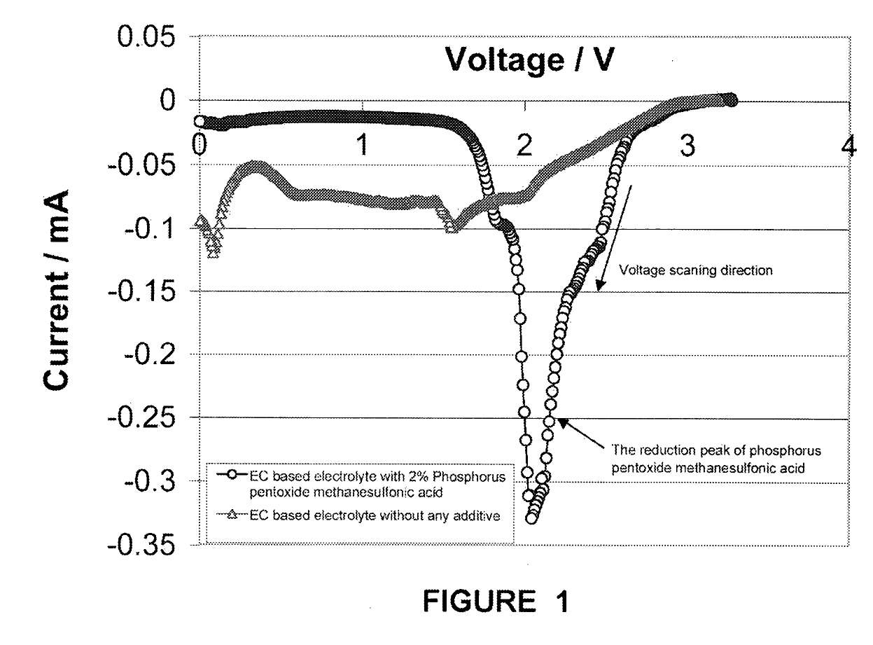

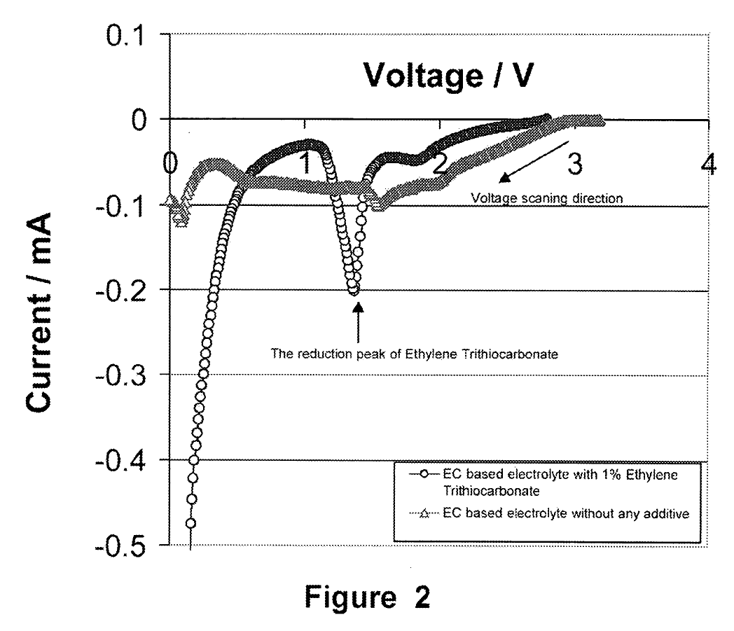

### DETAILED DESCRIPTION OF THE PREFERRED EMBODIMENTS

The preferred embodiment of the disclosed device and method resulting in an electrolyte having improved operational characteristics for SEI layer formation to thereby yield improved non-aqueous cells employs one or a combination of additives which are added to the electrolyte to be introduced into a lithium ion cell or lithium metal cell battery. Lithium ion cells or lithium metal cells employing the electrolyte are also shown in an additional preferred embodiment of the device which combines the improved electrolyte with a cell adapted to employ it.

The invention as herein disclosed enhances electrolytes employed in lithium ion cells or lithium metal cells. Such electrolytes include but are not limited to electrolytes which include solvents such as PC, EC, DMC, DEC combined with lithium salts, such as LiPF₆, LiPF₃(C₂F₅)₃, Li bis(oxalato) borate, and other lithium salts as would occur to those skilled in the art. To that conventional mixture of electrolyte is added one or a combination of the following additives which have been found to enhance the SEI layer properties during the initial charge of the cell. As noted, preferred concentrations for the electrolyte additives vary between 0.01%-20% for each additive. In a particularly preferred mode of the mixed electrolyte, a preferred concentration of 0.1%-5% for each additive of the electrolyte mixuture is used.

The structure of the first additive is R₁O₂S—[—P(═O) (OSO₂R₂)—O—]ₙ-SO₂R₃ where R1, R2 and R3 are independently or simultaneously an alkyl group, a phenyl group, or a halogen-substitute alkyl or/and phenyl groups. The studied compound is phosphorus pentoxide methanesulfonic acid with the structure R₁O₂S—[—P(═O) (OSO₂R₂)—O-]ₙ—SO₂R₃ where R1, R2 and R3 are all in the CH3 group. The liquid form of these additives makes them especially easy to incorporate into conventional battery manufacturing processes.

The second additive is phosphonic Acid Tris(2-n-butoxyethyl) Ester with the following structure: CH₃((CH₂)₃OCH₂CH₂O)₃P═O

The structure of the third additive is R₁R₂C(OSO₂R₃)—R₄C(OSO₂R₅)—R₆R₇C—R₈C(OSO₂R₉) where R1-R9 are independently or simultaneously an alkyl group, a phenyl group, or a halogen-substitute alkyl or/and phenyl group.

A preferred third additive example is 1,2,4-Tris(methane sulfonyloxy)butane with the following structure: C₇H₁₆O₉S₃.

Mixing the additives singularly or in combination with the solvent a lithium salt results in both an improved electrolyte solution and in an improved cell having an improved SEI layer once charged. One or a combination of the above-referenced additives are added to one of the conventionally employed electrolytes having a solvent such as EC, DMC, DEC and a lithium salt.

Once the additives are so combined with the electrolyte solution, the electrolyte is operatively placed into the cell which is then sealed in the desired can. The cell is then subjected to an initial charging process wherein the improved SEI layer resulting from the additive or additives in the electrolyte forms on the negative electrode.

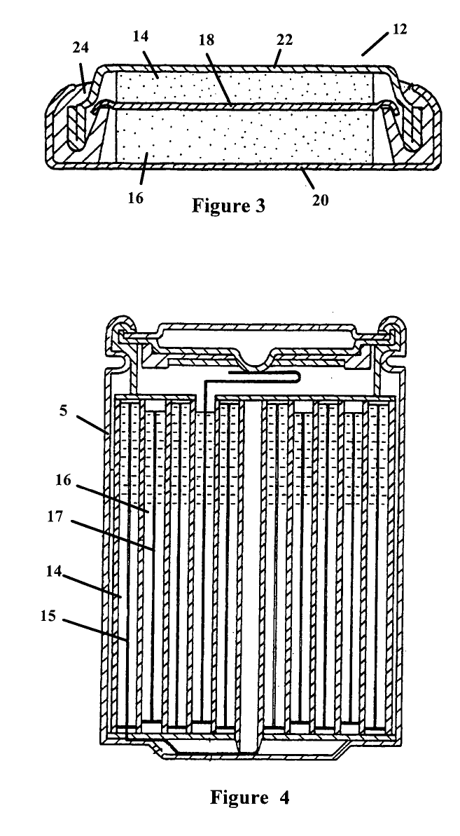

As shown in FIG. 3 the improved electrolyte mixture having the disclosed mixture of additives is employable in a non-aqueous electrolyte button style cell 12 which is depicted in a conventional configuration. In such a process a negative electrode 14 separated from positive electrode 16 by a porous separator 18 would be provided. The pair of electrodes are operatively encased by the positive can section 20 operatively electrically separated from the negative can section 22 by insulator 24. The above-referenced improved electrolyte would be employed in the formation thereof and the cell would be initially charged to form the improved SEI layer yielded by the inclusion of the chosen additives to the electrolyte.

FIG. 4 is a cross-sectional view of a non-aqueous electrolyte secondary cell or prismatic cell employing the improved electrolyte mixture noted above. In a method of manufacturing such a cell, a positive electrode 16 would be provided for operative placement adjacent to a positive current collector 17 and negative electrode 14 would be provided for operative positioning adjacent to the negative current collector 15. These components along with the electrolyte having the chosen mixture of additives herein described and disclosed would be operatively sealed in the battery can, and the cell would be charged initially to thereby form the improved SEI layer on the negative electrode 14.

Negative electrode active materials constituting the negative electrodes 14 for such cells which employ the additives to the electrolyte herein disclosed include Lithium and carbon; silicon and carbon; carbon and tin; and titanium, tin, and carbon. Of course other such active materials as would occur to those skilled in the art for a negative electrode are anticipated herein.

Positive electrode active materials employed in the positive electrode 16 in such batteries which employ the disclosed additives to the electrolyte as herein disclosed include, LiCoO₂, LiMn₂O₄, LiFePO₄, LiNiCoO₂, LiNiMnCoO₂, and LiV₂O₅ which are the most common active materials used in LiIon positive electrodes. Of course other such active materials as would occur to those skilled in the art for a positive electrode are anticipated herein.

The non-aqueous electrolyte cells of the present invention contain the non-aqueous electrolytic solutions explained above; however, the shape of the cells are not limited to that of the embodiment mentioned above and may be selected within the scope of the present invention. For example, it may be cylindrical shape, rectangular shape, coin-like shape, large size shape or the like.

The lithium ion cell or lithium metal cell battery resulting from the process employing one, two, or all of these additives yields a battery with improved cycle life, higher capacity resulting in better efficiency, and improved high temperature stability with diminished swelling during charging. The method, resulting electrolyte, and resulting improved cells shown in the drawings and described in detail herein disclose steps in a process, arrangements of elements of particular construction, and. configuration for illustrating preferred embodiments of structure and method of operation of the present invention. It is to be understood, however, that elements of different construction and configuration and different steps and process procedures and other arrangements thereof, other than those illustrated and described, may be employed for providing an improved SEI layer on the electrode of a lithium ion cell or lithium metal cell battery in accordance with the spirit of this invention.

As such, while the present invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. An electrolyte adapted to improve the SEI layer on the negative electrode of a lithium ion cell or lithium metal cell battery, said electrolyte comprising:
an organic solvent;
a lithium salt;
a compound having the structure R₁O₂S—[—P(═O) (OSO₂R₂)—O—]ₙ—SO₂R₃ where R1, R2 and R3 are independently or simultaneously an alkyl group, a phenyl group, or a halogen-substitute alkyl or/and phenyl groups; and
wherein said compound forms a film on the negative electrode at initial charging of the battery.

2. The electrolyte of claim 1 wherein said compound comprises:
phosphorus pentoxide methanesulfonic acid with the structure R₁O₂S—[—P(═O) (OSO₂R₂)—O—]ₙ—SO₂R₃ where R1, R2 and R3 are all in the CH3 group.

3. An electrolyte adapted to improve the SEI layer on the negative electrode of a lithium ion cell or lithium metal cell battery, said electrolyte comprising:
an organic solvent;
a lithium salt;
a compound consisting of phosphonic Acid Tris(2-n-butoxyethyl) Ester; and
wherein said compound forms a film on the negative electrode at initial charging of the battery.

4. The electrolyte of claim 3 wherein said compound has the structure: CH₃((CH₂)₃OCH₂CH₂O)₃P═O.

5. An electrolyte adapted to improve the SEI layer on the negative electrode of a lithium ion cell or lithium metal cell battery, said electrolyte comprising:
an organic solvent;
a lithium salt;
a compound having the structure R₁R₂C (OSO₂R₃)—R₄C(OSO₂R₅)—R₆R₇C—R₈C(OSO₂R₉) where R1-R9 are independently or simultaneously an alkyl group, a phenyl group, or a halogen-substitute alkyl or/and phenyl group; and
wherein said compound forms a film on the negative electrode at initial charging of the battery.

6. The electrolyte of claim 5 wherein said compound consists of 1,2,4-Tris(methane sulfonyloxy)butane with the structure: C₇H₁₆O₉S₃.

7. An electrolyte adapted to improve the SEI layer on the negative electrode of a lithium ion cell or lithium metal cell battery, said electrolyte comprising:
an organic solvent;
a lithium salt;
an additive, said additive including one or a combination of additives, from a group of additives consisting of:
a first compound having the structure R₁O₂S—[—P(═O) (OSO₂R₂)—O—]ₙ—SO₂R₃ where R1, R2 and R3 are independently or simultaneously an alkyl group, a phenyl group, or a halogen-substitute alkyl or/and phenyl groups;
a second compound of phosphonic Acid Tris(2-n-butoxyethyl) Ester having the structure: CH₃((CH₂)₃OCH₂CH₂O)₃P═O, and
a third compound having the structure R₁R₂C(OSO₂R₃)—R₄C(OSO₂R₅)—R₆R₇C—R₈C(OSO₂R₉) where where R1-9 are independently or simultaneously an alkyl group, a phenyl group, or a halogen-substitute alkyl or/and phenyl group; and
wherein said compound forms a film on the negative electrode at initial charging of the battery.

8. The electrolyte of claim 7 wherein said first compound consists of phosphorus pentoxide methanesulfonic acid with the structure R₁O₂S—[—P(═O) (OSO₂R₂)—O—]ₙ—SO₂R₃ where R1, R2 and R3 are all in the CH3 group.

9. The electrolyte of claim 7 wherein said third compound consists of 1,2,4-Tris(methane sulfonyloky)butane with the following structure: C₇H₁₆O₉S₃.

10. The electrolyte of claim 8 wherein said third compound consists of 1,2,4-Tris(methane sulfonyloxy)butane with the following structure: C₇H₁₆O₉S₃.

11. The electrolyte of claim 2 wherein said organic solvent is comprised from one or a combination of organic solvents from a group of organic solvents consisting of PC, EC, DMC, and DEC.

12. The electrolyte of claim 4 wherein said organic solvent is comprised from one or a combination of organic solvents from a group of organic solvents consisting of PC, EC, DMC, and DEC.

13. The electrolyte of claim 6 wherein said organic solvent is comprised from one or a combination of organic solvents from a group of organic solvents consisting of PC, EC, DMC, and DEC.

14. The electrolyte of claim 8 wherein said organic solvent is comprised from one or a combination of organic solvents from a group of organic solvents consisting of PC, EC, DMC, and DEC.

15. The electrolyte of claim 9 wherein said organic solvent is comprised from one or a combination of organic solvents from a group of organic solvents consisting of PC, EC, DMC, and DEC.

16. The electrolyte of claim 10 wherein said organic solvent is comprised from one or a combination of organic solvents from a group of organic solvents consisting of PC, EC, DMC, and DEC.

17. A method of forming a non-aqueous electrolyte button style cell having an improved SEI layer on the negative electrode employing the electrolyte of claim 7, comprising the steps of:
providing a positive electrode;
providing a negative electrode comprising a material selected from the group consisting of carbon, carbon composites, lithium metal, and lithium alloys;
providing a porous separator adapted for interposing between said positive electrode and said negative electrode;
forming an additive mixture from one or a combination of compounds selected from the group consisting of:
a first compound having the structure R₁O₂S—[—P(═O) (OSO₂R₂)—O—]ₙ—SO₂R₃ where R1, R2 and R3 are independently or simultaneously an alkyl group, a phenyl group, or a halogen-substitute alkyl or/and phenyl groups;
a second compound of phosphonic Acid Tris(2-n-butoxyethyl) Ester having the structure: CH₃((CH₂)₃OCH₂CH₂O)₃P═O, and
a third compound having the structure R₁R₂C(OSO₂R₃)—R₄C(OSO₂R₅)—R₆R₇C—R₈C(OSO₂R₉) where R1, R2 and R3 are independently or simultaneously an alkyl group, a phenyl group, or a halogen-substitute alkyl or/and phenyl groups;
dissolving said additive mixture into a non-aqueous electrolyte comprising a lithium salt and an organic solvent, interposing said electrolyte between the positive electrode and the negative electrode; and
operatively encasing said positive electrode, said negative electrode, said separator, and said electrolyte in a cell can; and
forming an SEI layer on said negative electrode by charging said cell.

18. A method of forming a non-aqueous electrolyte secondary or prismatic cell having an improved SEI layer on the negative electrode employing the electrolyte of claim 7, comprising the steps of:
providing positive electrode adjacent to positive current collector;
providing a negative electrode adjacent to negative current collector,
forming an additive mixture from one or a combination of compounds selected from the group consisting of:
a first compound having the structure R₁O₂S—[—P(═O) (OSO₂R₂)—O—]ₙ—SO₂R₃ where R1, R2 and R3 are independently or simultaneously an alkyl group, a phenyl group, or a halogen-substitute alkyl or/and phenyl groups;
a second compound of phosphonic Acid Tris(2-n-butoxyethyl) Ester having the structure: CH₃((CH₂)₃OCH₂CH₂O)₃P═O, and
a third compound having the structure R₁R₂C(OSO₂R₃)—R₄C(OSO₂R₅)—R₆R₇C—R₈C(OSO₂R₉) where R1, R2, and R3 are independently or simultaneously an alkyl group, a phenyl group, or a halogen-substitute alkyl or/and phenyl groups;
dissolving said additive mixture into a non-aqueous electrolyte comprised of a lithium salt and an organic solvent,
interposing said electrolyte between the positive electrode and the negative electrode; and
operatively encasing said positive electrode, said negative electrode, said positive current collector, said negative current collector and said electrolyte in a cell can; and
forming an SEI layer on said negative electrode by charging said cell.

19. The electrolyte of claim 17 wherein said first compound consists of phosphorus pentoxide methanesulfonic acid with the structure R₁O₂S—[—P(═O) (OSO₂R₂)—O—]ₙ—SO₂R₃ where R1, R2 and R3 are all in the CH3 group.

20. The electrolyte of claim 17 wherein said third compound consists of 1,2,4-Tris(methane sulfonyloxy)butane with the following structure: C₇H₁₆O₉S₃.

21. The electrolyte of claim 18 wherein said first compound consists of phosphorus pentoxide methanesulfonic acid with the structure R₁O₂S—[—P(═O) (OSO₂R₂)—O—]ₙ—SO₂R₃ where R1, R2 and R3 are all in the CH3 group.

22. The electrolyte of claim 18 wherein said third compound consists of 1,2,4-Tris(methane sulfonyloxy)butane with the following structure: C₇H₁₆O₉S₃.

23. The electrolyte of claim 1 wherein said compound has a concentration of 0.01%-20% of said electrolyte.

24. The electrolyte of claim 3 wherein said compound has a concentration of 0.01%-20% of said electrolyte.

25. The electrolyte of claim 5 wherein said compound has a concentration of 0.01%-20% of said electrolyte.

26. The electrolyte of claim 7 wherein said additive has a concentration between 0.01%-20% of each of said first compound, said second compound and said third compound included from the group of compounds included in said additive.

27. The electrolyte of claim 7 wherein said additive has a concentration between 0.1%-5% of each of said first compound, said second compound and said third compound included from the group of compounds in said additive.
